(19) United States
(12) Patent Application Publication
(10) Pub. No.: US 2024/0049249 A1
(43) Pub. Date: Feb. 8, 2024

(54) REPORT FOR A DECODING OUTCOME OF A DCI FORMAT

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/354,553

(22) Filed: Jul. 18, 2023

Related U.S. Application Data
(60) Provisional application No. 63/394,434, filed on Aug. 2, 2022.

(51) Int. Cl. H04W 72/232

(52) U.S. Cl. CPC H04W 72/232

(57) ABSTRACT

A UE includes a transceiver configured to receive first information related to a set of operation states on a cell, second information related to search space sets for receiving PDCCHs, and the PDCCHs. A first PDCCH provides a first DCI format, CRC bits of the first DCI format are scrambled by a first RNTI, and the first DCI format indicates a first index from a set of indices corresponding to the set of operation states on the cell. The UE further includes a processor operably coupled to a transceiver. The processor is configured to determine a first set of reception occasions for the PDCCHs, and absence of a correct reception of the first DCI format for the first set of reception occasions. The transceiver is further configured to transmit a PUCCH in response to the absence of the reception of the first DCI format for the set of reception occasions.

### CROSS-REFERENCE TO RELATED APPLICATION(S) AND CLAIM OF PRIORITY

This application claims priority under 35 U.S.C. § 119(e) to U.S. Provisional Patent Application No. 63/394,434 filed on Aug. 2, 2023. The above-identified provisional patent application is hereby incorporated by reference in its entirety.

### TECHNICAL FIELD

This disclosure relates generally to wireless communications systems. More specifically, this disclosure relates to reporting a decoding outcome of a downlink control information (DCI) format.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for reporting a decoding outcome of a DCI format.

In one embodiment, a user equipment (UE) is provided. The UE includes a transceiver configured to receive first information related to a set of operation states on a cell, second information related to search space sets for receiving physical downlink control channels (PDCCHs), and the PDCCHs. A first PDCCH from the PDCCHs provides a first downlink control information (DCI) format, cyclic redundancy check (CRC) bits of the first DCI format are scrambled by a first radio network temporary identifier (RNTI), and the first DCI format indicates a first index from a set of indices corresponding to the set of operation states on the cell. The UE further includes a processor operably coupled to a transceiver. The processor is configured to determine a first set of reception occasions for the PDCCHs, and absence of a correct reception of the first DCI format for the first set of reception occasions. The transceiver is further configured to transmit a physical uplink control channel (PUCCH) in response to the absence of the reception of the first DCI format in the first set of reception occasions.

In another embodiment, a base station (BS) is provided. The BS includes a transceiver configured to transmit first information related to a set of operation states on a cell, second information related to search space sets for transmitting PDCCHs, and the PDCCHs. A first PDCCH from the PDCCHs provides a first DCI format, CRC bits of the first DCI format are scrambled by a first RNTI, and the first DCI format indicates a first index from a set of indices corresponding to the set of operation states on the cell. The BS further includes a processor operably coupled to a transceiver. The processor configured to determine a first set of transmission occasions for the PDCCHs. The transceiver is further configured to receive a PUCCH in response to the transmission of the first DCI format in the first set of transmission occasions.

In yet another embodiment, a method is provided. The method includes receiving first information related to a set of operation states on a cell, second information related to search space sets for receiving PDCCHs, and the PDCCHs. A first PDCCH from the PDCCHs provides a first DCI format, CRC bits of the first DCI format are scrambled by a first RNTI, and the first DCI format indicates a first index from a set of indices corresponding to the set of operation states on the cell. The method further includes determining a first set of reception occasions for the PDCCHs, and absence of a correct reception of the first DCI format for the first set of reception occasions. The method further includes transmitting a PUCCH in response to the absence of the reception of the first DCI format in the first set of reception occasions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example gNB according to embodiments of the present disclosure;

FIG. 3B illustrates an example UE according to embodiments of the present disclosure;

FIG. 4 illustrates an example transmitter structure using OFDM according to embodiments of the present disclosure;

FIG. 5 illustrates an example receiver structure using OFDM according to embodiments of the present disclosure;

FIG. 6 illustrates an example encoding process for a DCI format according to embodiments of the present disclosure;

FIG. 7 illustrates an example decoding process for a DCI format according to embodiments of the present disclosure;

FIG. 8 illustrates an example method for adaptation of network (NW) operation states on a cell by physical layer signaling according to embodiments of the present disclosure;

FIG. 9 illustrates an example method for a UE to transmit a PUCCH indicating incorrect reception for a DCI format 2_8 according to embodiments of the present disclosure;

FIG. 10 illustrates an example method 1000 for a UE to receive PDCCH candidates for detection of DCI format 2_8 after the UE transmits a PUCCH indicating incorrect reception of DCI format 2_8 according to embodiments of the present disclosure;

FIG. 11 illustrates an example method 1100 for a UE to communicate with a serving gNB after the UE fails to correctly receive a DCI format 2_8 indicating a NW operation state according to embodiments of the present disclosure;

FIG. 12 illustrates an example method 1200 for a UE to communicate with a serving gNB after the UE fails to correctly receive a DCI format 2_8 indicating a NW operation state according to embodiments of the present disclosure; and

FIG. 13 illustrates an example method 1300 for reporting a decoding outcome of a DCI format.

### DETAILED DESCRIPTION

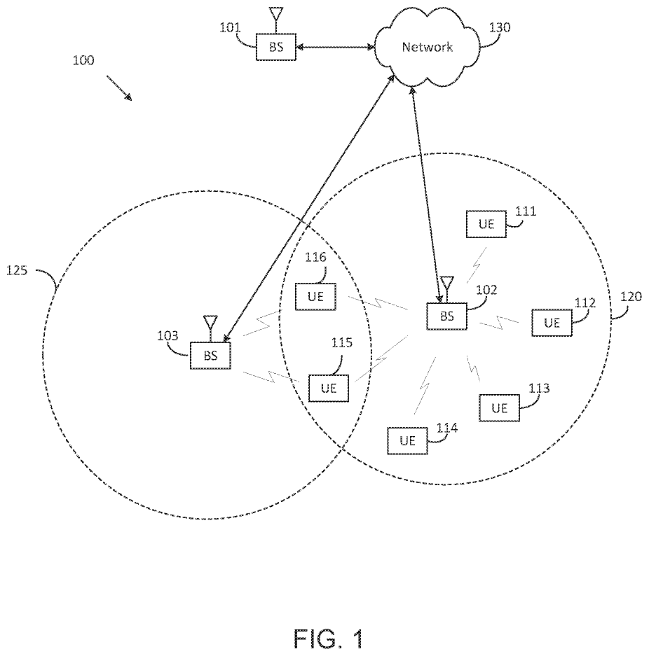

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNB s 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for reporting a decoding outcome of a DCI format. In certain embodiments, one or more of the gNBs 101-103 includes circuitry, programing, or a combination thereof, to support reporting of a decoding outcome of a DCI format in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

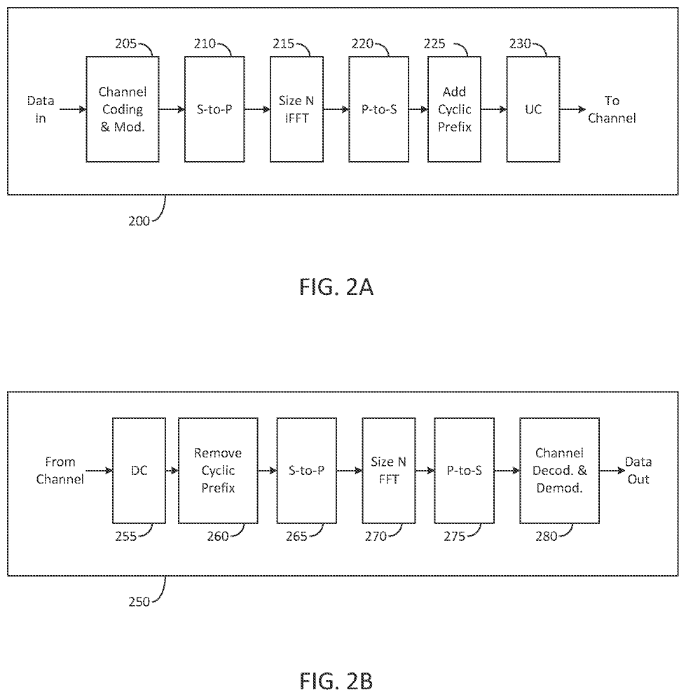

FIGS. 2A and 2B illustrate example wireless transmit and receive paths according to embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

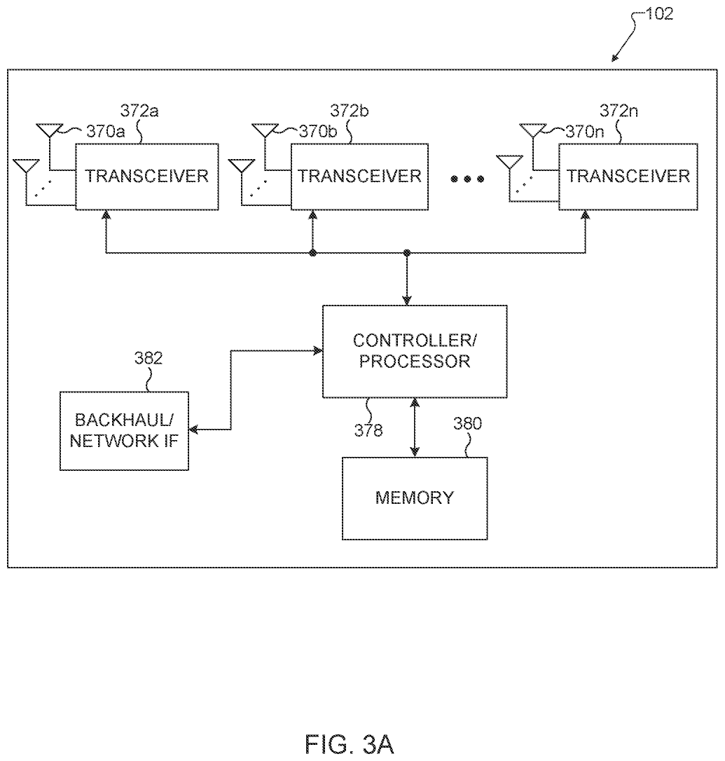

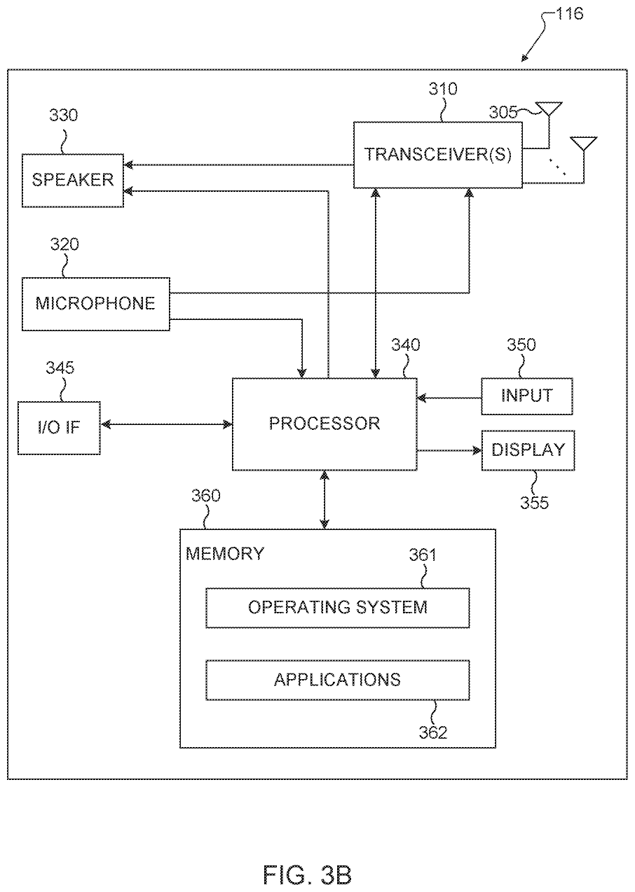

FIG. 3A illustrates an example gNB 102 according to embodiments of the present disclosure. The embodiment of the gNB 102 illustrated in FIG. 3A is for illustration only, and the gNBs 101 and 103 of FIG. 1 could have the same or similar configuration. However, gNBs come in a wide variety of configurations, and FIG. 3A does not limit the scope of this disclosure to any particular implementation of a gNB.

As shown in FIG. 3A, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of UL channel signals and the transmission of DL channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support reporting of a decoding outcome of a DCI format as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 378 could include a RAM, and another part of the memory 378 could include a Flash memory or other ROM.

Although FIG. 3A illustrates one example of gNB 102, various changes may be made to FIG. 3A. For example, the gNB 102 could include any number of each component shown in FIG. 3A. Also, various components in FIG. 3A could be combined, further subdivided, or omitted and additional components could be added according to particular needs.

FIG. 3B illustrates an example UE 116 according to embodiments of the present disclosure. The embodiment of the UE 116 illustrated in FIG. 3B is for illustration only, and the UEs 111-115 of FIG. 1 could have the same or similar configuration. However, UEs come in a wide variety of configurations, and FIG. 3B does not limit the scope of this disclosure to any particular implementation of a UE.

As shown in FIG. 3B, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for reporting a decoding outcome of a DCI format as discussed in greater detail below. The processor 340 can move data into or out of the memory 360 as required by an executing process. In some embodiments, the processor 340 is configured to execute the applications 362 based on the OS 361 or in response to signals received from gNB s or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3B illustrates one example of UE 116, various changes may be made to FIG. 3B. For example, various components in FIG. 3B could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3B illustrates the UE 116 configured as a mobile telephone or smartphone, UEs could be configured to operate as other types of mobile or stationary devices.

The following documents and standards descriptions are hereby incorporated into the present disclosure as if fully set forth herein: [1] 3GPP TS 38.211 v17.2.0, “NR; Physical channels and modulation.” [2] 3GPP TS 38.212 v17.2.0, “NR; Multiplexing and channel coding.” [3] 3GPP TS 38.213 v17.2.0, “NR; Physical layer procedures for control.” [4] 3GPP TS 38.214 v17.2.0, “NR; Physical layer procedures for data.” [5] 3GPP TS 38.321 v17.1.0, “NR; Medium Access Control (MAC) Protocol Specification.” [6] 3GPP TS 38.331 v17.1.0, “NR; Radio Resource Control (RRC) Protocol Specification.”

In the following, an italicized name for a parameter implies that the parameter is provided by higher layers.

DL transmissions or UL transmissions may be based on an OFDM waveform including a variant using DFT precoding that is known as DFT-spread-OFDM that is typically applicable to UL transmissions.

A unit for DL signaling or for UL signaling on a cell may be referred to as a slot and may include one or more symbols. A bandwidth (BW) unit may be referred to as a resource block (RB). One RB may include a number of sub-carriers (SCs). For example, a slot may have a duration of one millisecond and an RB may have a bandwidth of 180 kHz and include 12 SCs with inter-SC spacing of 15 kHz. A sub-carrier spacing (SCS) may be determined by a SCS configuration μ as 2^{μ}·15 kHz. A unit of one sub-carrier over one symbol may be referred to as resource element (RE). A unit of one RB over one symbol may be referred to as physical RB (PRB).

DL signaling may include physical downlink shared channels (PDSCHs) conveying information content, PDCCHs conveying DL control information (DCI), and reference signals (RS). A PDCCH may be transmitted over a variable number of slot symbols including one slot symbol and over a number of control channel elements (CCEs) from a predetermined set of numbers of CCEs which may be referred to as CCE aggregation level within a control resource set (CORESET) as described in 3GPP TS 36.211 v17.2.0, “NR; Physical channels and modulation”, and 3GPP TS 38.213 v17.2.0 “NR; Physical Layer procedures for control”.

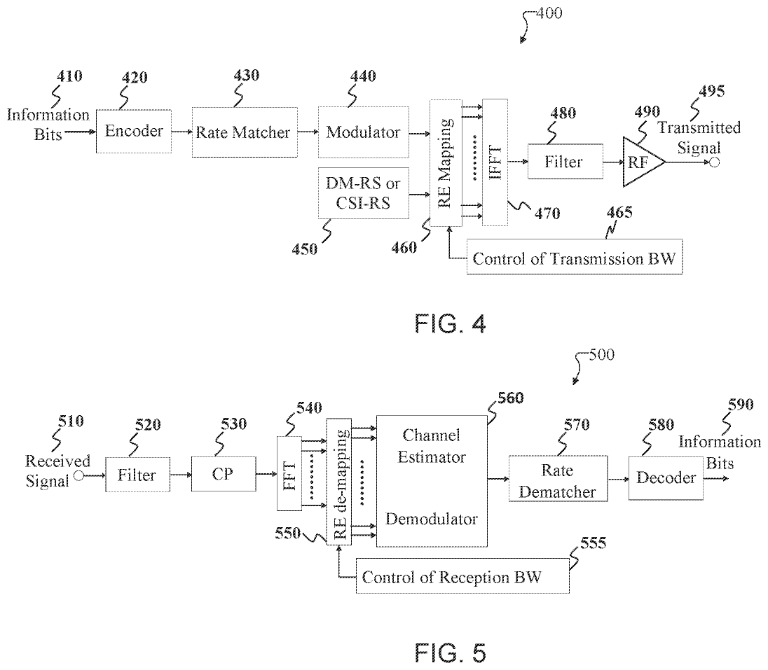

FIG. 4 illustrates an example transmitter structure using OFDM 400 according to embodiments of the present disclosure. The embodiment of the transmitter structure illustrated in FIG. 4 is for illustration only. However, transmitters come in a wide variety of configurations, and FIG. 4 does not limit the scope of this disclosure to any particular implementation of a transmitter structure.

In the example of FIG. 4, information bits, such as DCI bits or data bits 410, may be encoded by encoder 420, rate matched to assigned time/frequency resources by rate matcher 430, and modulated by modulator 440. Subsequently, modulated encoded symbols and DM-RS or CSI-RS 450 may be mapped to REs 460 by RE mapping unit 465, an inverse fast Fourier transform (IFFT) may be performed by filter 470, a cyclic prefix (CP) may be added by CP insertion unit 480, and a resulting signal may be filtered by filter 490 and transmitted by a radio frequency (RF) unit 495.

Although FIG. 4 illustrates one example of a transmitter structure using OFDM 400, various changes may be made to FIG. 4. For example, the transmitter structure could include any number of each component shown in FIG. 4. Also, various components in FIG. 4 could be combined, further subdivided, or omitted and additional components could be added according to particular needs.

FIG. 5 illustrates an example receiver structure using OFDM 500 according to embodiments of the present disclosure. The embodiment of the receiver structure illustrated in FIG. 5 is for illustration only. However, receivers come in a wide variety of configurations, and FIG. 5 does not limit the scope of this disclosure to any particular implementation of a receiver structure.

In the example of FIG. 5, a received signal 510 may be filtered by filter 520, a CP removal unit may remove a CP 530, a filter 540 may apply a fast Fourier transform (FFT), RE de-mapping unit 550 may de-map REs selected by BW selector unit 555, received symbols may be demodulated by a channel estimator and a demodulator unit 560, a rate de-matcher 570 may restore a rate matching, and a decoder 580 may decode the resulting bits to provide information bits 590.

Although FIG. 5 illustrates one example of a receiver structure using OFDM 500, various changes may be made to FIG. 5. For example, the receiver structure could include any number of each component shown in FIG. 5. Also, various components in FIG. 5 could be combined, further subdivided, or omitted and additional components could be added according to particular needs.

DCI may serve several purposes. A DCI format may include information elements (IEs) and may be used for scheduling a PDSCH (DL DCI format) or a PUSCH (UL DCI format) transmission. A DCI format may include cyclic redundancy check (CRC) bits in order for a UE to confirm a correct detection. A DCI format type may be identified by a radio network temporary identifier (RNTI) that scrambles the CRC bits. For a DCI format scheduling a PDSCH or a PUSCH for a single UE with RRC connection to a gNB, the RNTI may be a cell RNTI (C-RNTI) or another RNTI type such as a MCS-C-RNTI. For a DCI format scheduling a PDSCH conveying system information (SI) to a group of UEs, the RNTI may be a SI-RNTI. For a DCI format scheduling a PDSCH providing a response to a random access (RA) from a group of UEs, the RNTI may be a RA-RNTI. For a DCI format scheduling a PDSCH providing contention resolution in Msg4 of an RA process, the RNTI may be a temporary C-RNTI (TC-RNTI). For a DCI format scheduling a PDSCH paging a group of UEs, the RNTI may be a P-RNTI. For a DCI format providing transmission power control (TPC) commands to a group of UEs, the RNTI may be a TPC-RNTI, and so on. Each RNTI type may be configured to a UE through higher layer signaling. A UE may decode at multiple candidate locations for potential PDCCH transmissions.

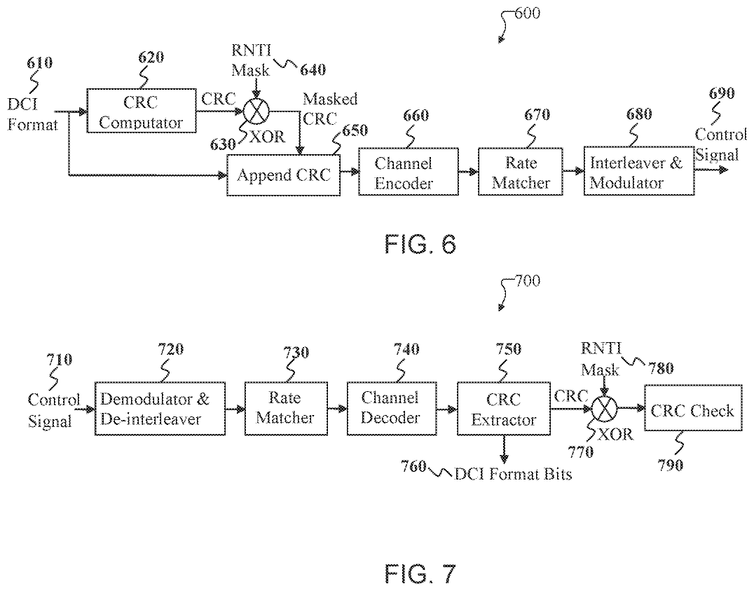

FIG. 6 illustrates an example encoding process for a DCI format 600 according to embodiments of the present disclosure. The embodiment of the encoding process illustrated in FIG. 6 is for illustration only. FIG. 6 does not limit the scope of this disclosure to any particular implementation of an encoding process for a DCI format.

In the example of FIG. 6 a gNB (such as gNB 102 of FIG. 1) may separately encode and transmit each DCI format in a respective PDCCH. When applicable, an RNTI for a UE that a DCI format is intended for may mask a CRC of the DCI format codeword in order to enable the UE to identify the DCI format. For example, the CRC may include 24 bits and the RNTI may include 16 bits or 24 bits. The CRC of (non-coded) DCI format bits 610 may be determined using a CRC computation unit 620, and the CRC may be masked using an exclusive OR (XOR) operation unit 630 between CRC bits and RNTI bits 640. The XOR operation may be defined as XOR(0,0)=0, XOR(0,1)=1, XOR(1,0)=1, XOR(1,1)=0. The masked CRC bits may be appended to DCI format information bits using a CRC append unit 650. An encoder 660 may perform channel coding, such as polar coding, followed by rate matching to allocated resources by rate matcher 670. Interleaving and modulation units 680 may apply interleaving and modulation, such as QPSK, and the output control signal 690 may be transmitted.

Although FIG. 6 illustrates one example encoding process for a DCI format 600, various changes may be made to FIG. 6. For example, the encoding process could include any number of each component shown in FIG. 6. Also, various components in FIG. 6 could be combined, further subdivided, or omitted and additional components could be added according to particular needs.

FIG. 7 illustrates an example decoding process for a DCI format 700 according to embodiments of the present disclosure. The embodiment of the decoding process illustrated in FIG. 7 is for illustration only. FIG. 7 does not limit the scope of this disclosure to any particular implementation of a decoding process for a DCI format.

In the example of FIG. 7, a received control signal 710 may be demodulated and de-interleaved by a demodulator and a de-interleaver 720. A rate matching applied at a gNB transmitter may be restored by rate matcher 730, and resulting bits may be decoded by decoder 740. After decoding, a CRC extractor 750 may extract CRC bits and provide DCI format information bits 760. The DCI format information bits may be de-masked 770 by an XOR operation with a RNTI 780 (when applicable) and a CRC check may be performed by unit 790. When the CRC check succeeds (check-sum is zero), the DCI format information bits may be considered to be valid. When the CRC check does not succeed, the DCI format information bits may be considered to be invalid.

Although FIG. 7 illustrates one example decoding process for a DCI format 700, various changes may be made to FIG. 7. For example, the decoding process could include any number of each component shown in FIG. 7. Also, various components in FIG. 7 could be combined, further subdivided, or omitted and additional components could be added according to particular needs.

For each DL bandwidth part (BWP) indicated to a UE in a serving cell, the UE may be provided by higher layer signaling with P≤3 control resource sets (CORESETs). For each CORESET, the UE may be provided a CORESET index p, 0≤p<12, a DM-RS scrambling sequence initialization value, a precoder granularity for a number of resource element groups (REGs) in the frequency domain where the UE can assume use of a same DM-RS precoder, a number of consecutive symbols for the CORESET, a set of resource blocks (RBs) for the CORESET, CCE-to-REG mapping parameters, an antenna port quasi co-location, from a set of antenna port quasi co-locations, indicating quasi co-location information of the DM-RS antenna port for PDCCH reception in a respective CORESET, and an indication for a presence or absence of a transmission configuration indication (TCI) field for DCI format 1_1 transmitted by a PDCCH in CORESET p.

For each DL BWP configured to a UE in a serving cell, the UE may be provided by higher layers with S≤10 search space sets. For each search space set from the S search space sets, the UE may be provided a search space set index s, 0≤s<40, an association between the search space set s and a CORESET p, a PDCCH monitoring periodicity of kₛ slots and a PDCCH monitoring offset of o s slots, a PDCCH monitoring pattern within a slot, indicating first symbol(s) of the CORESET within a slot for PDCCH monitoring, a duration of Tₛ<kₛ slots indicating a number of slots that the search space set s exists, a number of PDCCH candidates Mₛ^{(L)} per CCE aggregation level L, and an indication that search space set s is either a CSS set or a USS set. When search space set s is a CSS set, the UE may monitor PDCCH for detection of DCI format 2_x, where x ranges from 0 to 7 as described in TS 38.212 v17.2.0, or for DCI formats associated with scheduling broadcast/multicast PDSCH receptions, and possibly for DCI format 0_0 and DCI format 1_0.

A UE may determine a PDCCH monitoring occasion on an active DL BWP from the PDCCH monitoring periodicity, the PDCCH monitoring offset, and the PDCCH monitoring pattern within a slot. For search space set s, the UE may determine that a PDCCH monitoring occasion(s) exists in a slot with number n_{s,f}^{μ} in a frame with number n_{f} if (n_{f}·Nₛₗₒₜ^{frame.μ}+n_{s,f}^{μ}−oₛ)mod kₛ=0. The UE may monitor PDCCH candidates for search space set s for Tₛ consecutive slots, starting from slot n_{s,f}^{μ} and may refrain from monitoring PDCCH candidates for search space set s for the next kₛ−Tₛ consecutive slots. The UE may determine CCEs for monitoring PDCCH according to a search space set based on a search space equation as described in TS 38.213 v17.2.0.

Network energy saving is becoming a performance indicator of greater importance for networks as the energy cost represents a substantial portion of the overall operating cost while an increasing demand for applications with higher data rates requires the use of more antennas and bands which in turn requires a higher energy consumption and has a larger environmental impact. To reduce energy consumption, it may be advantageous for a network to adapt operation according to traffic conditions and operate in different network energy saving (NES) modes or NW operation states on a cell. A NW operation state may include one or more operation states on respective one or more groups of cells of the NW. A group of cells includes one or more cells.

In one example, in absence of UL/DL traffic, a network may reduce operation in time/frequency/spatial/power domains to a minimum necessary for UEs to maintain an RRC connection to a serving gNB. In another example, while in presence of UL/DL traffic, the NW may change a NW operation state to one corresponding to the traffic characteristics. Thus, the network may operate in various operating states, for example according to considerations for NW energy savings and for servicing required traffic. In another example the network may use a number of NW operation states on a cell, and different NW operation states, or simply different states, or operation states, for the network may be associated to transmission of specific signaling or to monitoring/reception of specific signaling by a serving gNB or by a UE, or may be associated to specific characteristics of transmissions and/or receptions, such as a periodicity or a transmit power.

For example, a first NW operation state may correspond to use of all/most resources in one or more of time/frequency/spatial/power domains by a serving gNB. In another example, a second NW operation state may correspond to minimal or no use of any such resources. In another example, intermediate states may correspond to reduced utilization of most such resources such as for example, support of transmissions or receptions of only a subset of possible signals/channels or support of transmissions/receptions only in non-consecutive time intervals or only in a bandwidth that is smaller than a maximum bandwidth.

Present networks may have limited capability to adapt an operation state in one or more of time/frequency/spatial/power domains. For example, in NR, there are transmissions or receptions by a serving gNB that are expected by UEs, such as transmissions of SS/PBCH blocks or system information or of CSI-RS indicated by higher layers, or receptions of PRACH or SRS indicated by higher layers. Reconfiguration of a NW operation state involves higher layer signaling by a SIB or by UE-specific RRC. That is a slow process and requires substantial signaling overhead, particularly for UE-specific RRC signaling. For example, it is currently not practical or possible for a network in typical deployments to enter an energy saving state where the network does not transmit or receive due to low traffic as, in order to obtain material energy savings, the network needs to suspend transmissions or receptions for several tens of milliseconds and preferably for even longer time periods. A similar inability exists for suspending transmission or receptions for shorter time periods as a serving gNB may need to transmit SS/PBCH blocks every 5 msec and, in TDD systems with UL-DL configurations having few UL symbols in a period, the serving gNB may need to receive PRACH or SRS in most UL symbols in a period.

In present NWs, adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality would be limited or none, is currently limited as there are no procedures for a serving gNB to perform fast adaptation of a NW operation state, with small signaling overhead, while simultaneously informing all UEs.

The general principle for adaptation of NW operation states on a cell by physical layer signaling includes a serving gNB indicating to a UE a set of NW operation states on the cell by higher layer signaling, such as by a SIB or UE-specific RRC signaling, and transmitting a PDCCH that provides a DCI format, referred to as DCI format 2_8 in the disclosure, indicating an index to the set of NW operation states on the cell for the UE to determine an update of NW operation states. A NW operation state may include one or more operation states on respective one or more groups of cells of the NW. A group of cells includes one or more cells.

For example, in a power domain, a first NW operation state may be associated with a first value of parameter ss-PBCH-BlockPower providing an average energy per resource element (EPRE) with secondary synchronization signals (SSS) in dBm, and a second NW operation state may be associated with a second value of a parameter ss-PBCH-BlockPower. For example, first and second NW operation states on a cell may be respectively associated with first and second values of parameter powerControlOffsetSS that provides a power offset (in dB) of non-zero power (NZP) CSI-RS RE to SSS RE.

For example, in a frequency domain, first and second NW operation states on a cell may be respectively associated with first and second values of a parameter locationAndBandwidth that indicates a frequency domain location and a bandwidth for receptions or transmissions by UEs.

For example, in a spatial domain, first and second NW operation states on a cell may be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter active CoresetPoolIndex that coresetPoolIndex values for PDCCH transmissions in corresponding CORESETs and UEs can skip PDCCH receptions in a CORESET with coresetPoolIndex value that is not indicated by active CoresetPoolIndex.

For example, in a time domain, first and second NW operation states on a cell may be respectively associated with first and second values of a parameter ssb-PeriodicityServingCell that indicates a transmission periodicity in milliseconds for SS/PBCH blocks, or with first and second values of a parameter ssb-PositionsInBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted.

A serving gNB may provide a UE one or more search space sets to monitor PDCCH for detection of a DCI format 2_8 that indicates NW operation states on a cell as described in the subsequent embodiments of the present disclosure. The search space sets may be separate from other search space sets that the serving gNB provides to the UE or some or all search space sets may be common and the UE may monitor PDCCH for the detection of both the DCI format 2_8 that indicates NW operation states on the cell and for other DCI formats providing information for scheduling PDSCH receptions or PUSCH transmissions or SRS transmissions, or providing other control information for the UE to adjust parameters related to transmissions or receptions. The CRC bits of the DCI format 2_8 corresponding to PDCCHs monitored in different search spaces can be scrambled by different RNTIs, and when more than one DCI format 2_8 corresponding to PDCCHs monitored in a same search space, CRC bits of each DCI format 2_8 can be scrambled by different RNTIs. The search space sets may be CSS sets or USS sets. When the search space sets are CSS sets, a serving gNB may indicate the search space sets associated with DCI format 2_8 through higher layer signaling in a SIB or through UE-specific RRC signaling. A UE may monitor PDCCH for detection of DCI format 2_8 both in the RRC CONNECTED state and in the RRC_INACTIVE state according to the corresponding search space sets and DRX operation may not apply for PDCCH receptions that provide DCI format 2_8.

A UE may receive PDCCHs providing DCI format 2_8 in an active DL BWP. Alternatively, a UE may receive PDCCHs providing DCI format 2_8 in an initial DL BWP that was used by all UEs (or an initial DL BWP that was used by all UEs that support a feature of adaptation of NW operation states) to perform initial access and establish RRC connection with a serving gNB. The latter option enables a single PDCCH transmission with DCI format 2_8 from the serving gNB to all UEs because the initial DL BWP is common to all UEs, while the former option avoids a BWP switching delay because a UE receives PDCCHs providing DCI format 2_8 in the active DL BWP. In another example, the serving gNB may indicate the DL BWP (active

DL BWP or initial DL BWP) for PDCCH receptions that provide DCI format 2_8 through higher layer signaling, for example in a SIB.

Transmission of a PDCCH providing DCI format 2_8 in frequent time intervals, such as every 10 msec or every 10 slots, may not be beneficial to a NW for several reasons. A first reason is that such transmission may not be necessary because, in typical deployments, an adaptation of a NW operation state may be an infrequent event and frequent transmission of a PDCCH with DCI format 2_8 to indicate a same NW operation state would then result to unnecessary signaling overhead and also limit an ability of UEs for power savings by entering a sleep mode and skipping PDCCH receptions. An update of a NW operation state involves a transition time where communication between a serving gNB and UEs is impacted because parameters associated with transmissions/receptions need to be adjusted among different NW operation states on a cell. For example, when a gNB transitions between first and second NW operation states that support a smaller and a larger BW, respectively, UEs may need to retune their operations to the larger BW, provide corresponding CSI reports, and so on. For example, when a gNB transitions between third and fourth NW operation states that support transmissions in every slot and transmission in every 5 slots, respectively, the slot where the UE needs to perform measurements may need to change, or the UE may need to readjust a periodicity of SPS PDSCH receptions, and so on. A second reason is that frequent transmission of a PDCCH providing DCI format 2_8 hinders energy savings for a NW as the NW cannot enter a long sleep mode that provides most energy savings.

If a UE fails to correctly decode a DCI format 2_8, the UE may be unaware of a current NW operation state and that may have detrimental effects to the quality of service, to UE power consumption, and so on. For example, when DCI format 2_8 indicates a NW operation state where a serving gNB does not transmit or transmits infrequently, PDCCH monitoring by the UE in slots of no transmissions from the gNB would unnecessarily increase UE power consumption. The same would apply for SPS PDSCH receptions with an additional penalty of the UE unnecessarily transmitting a PUCCH with corresponding HARQ-ACK information or increasing a power of a PUCCH transmission due to inclusion of unnecessary HARQ-ACK information leading to a larger HARQ-ACK payload, or even result to incorrect PUSCH receptions by the gNB as the UE may multiplex HARQ-ACK information in a PUSCH that the gNB does not expect and is unware of. When DCI format 2_8 indicates a NW operation state where a serving gNB starts frequent transmissions, the UE may miss PDCCH monitoring occasions and scheduled PDSCH receptions or PUSCH transmissions leading to resource waste for the network and reduced quality of service for the UE. When a periodicity of PDCCH transmissions providing DCI format 2_8 is long, such as tens of milliseconds or even seconds, a failure by UEs to correctly receive DCI format 2_8 may have a large impact on the NW operation, the UE power consumption, and the quality of service and such impact may be larger than a corresponding one when UEs fail to correctly receive a SIB update when a serving gNB transmits in every slot as such update is relatively frequent such as every 20 milliseconds.

A mechanism to improve robustness for communication of data information in transport blocks is to provide acknowledgement information so that HARQ retransmissions for the transport blocks may be supported and the data information may be delivered with high reliability. It may be beneficial to extend support for retransmissions to a PDCCH that provides a DCI format, and in particular DCI format 2_8 indicating NW operation states on a cell, as such mechanism may mitigate the various problems that can exist when UEs do not correctly receive/decode the DCI format 2_8. Further, it is important to enable all UEs to provide acknowledgement information for a DCI format 2_8 reception and to minimize corresponding PUCCH resource overhead while enabling a serving gNB to determine whether or not a retransmission of a PDCCH providing DCI format 2_8 is needed. That objective may be accomplished by considering that only UEs that did not correctly receive DCI format 2_8 need to provide a corresponding (negative) acknowledgement information while a (positive) acknowledgement information for correct reception of DCI format 2_8 may not be necessary.

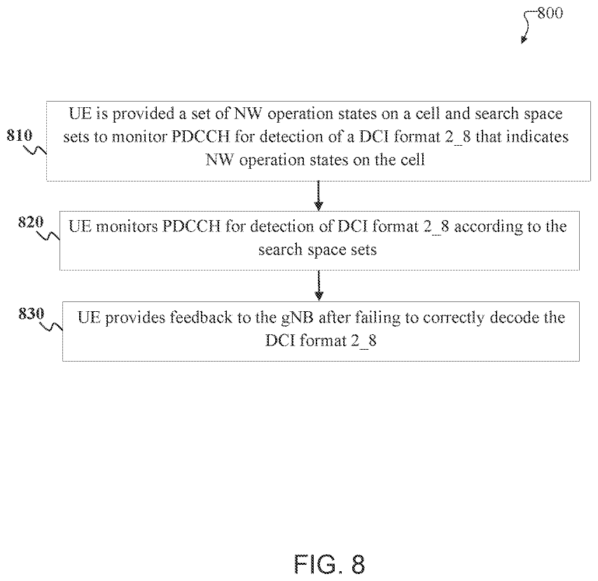

FIG. 8 illustrates an example method 800 for adaptation of NW operation states on a cell by physical layer signaling according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of adaptation of NW operation states on the cell by physical layer signaling could be used without departing from the scope of this disclosure.

As illustrated in FIG. 8, the method 800 begins at step 810. At step 810, a UE is provided a set of NW operation states on a cell and search space sets to monitor PDCCH for detection of a DCI format 2_8 that indicates NW operation states on the cell. At step 820, the UE monitors PDCCH for detection of DCI format 2_8 according to the search space sets. At step 830, the UE provides feedback to the gNB after failing to correctly decode the DCI format 2_8.

Although FIG. 8 illustrates one example of a method 800 for adaptation of NW operation states on a cell by physical layer signaling, various changes may be made to FIG. 8. For example, while shown as a series of steps, various steps in FIG. 8 could overlap, occur in parallel, occur in a different order, or occur any number of times.

Therefore, there is a need to enable a UE to provide information for a decoding outcome of a DCI format and in particular for a UE to indicate an incorrect decoding outcome for the DCI format.

There is another need to avoid a requirement for a large number of PUCCH resources in order to enable all UEs of a serving gNB to indicate incorrect reception of a DCI format 2_8 .

There is yet another need to determine PDCCH monitoring occasions for DCI format 2_8 in response to information reports by UEs for incorrect reception of a DCI format 2_8 in a previous respective PDCCH monitoring occasion.

Throughout the disclosure, a NW operation state on a cell is also referred to as a NW operation mode or NW operation configuration. The terms “NW operation state”, “NW operation mode”, or “NW operation configuration” are used interchangeably in this disclosure to refer to a network operation that may be dynamically adapted in order to save energy and/or based on the traffic types and load, so that the network may operate in more than one state. A NW operation state may include one or more operation states on respective one or more groups of cells of the NW. A group of cells includes one or more cells.

The embodiments of the disclosure are generally applicable to any DCI format provided by PDCCH receptions according to CSS sets. For brevity and for the description of the exemplary embodiments, the disclosure considers DCI format 2_8 indicating NW operation states on a cell.

A UE may transmit a PUCCH to indicate an incorrect reception for DCI format 2_8 . The PUCCH transmission may be based on PUCCH format 0 or on PUCCH format 1, as described in TS 38.211 v17.2.0 and TS 38.213 v17.2.0. A UE may transmit the PUCCH only to indicate an incorrect reception of DCI format 2_8 and may refrain from transmitting a PUCCH to indicate correct reception of DCI format 2_8 . A PUCCH resource for the PUCCH transmission may be common to all UEs, and the PUCCH resource can be provided by a SIB, since a serving gNB may transmit another PDCCH providing a DCI format 2_8 with CRC bits scrambled by a same or different RNTI than the one used for the DCI format 2_8 provided by the previous PDCCH transmission, upon detection of a PUCCH transmission in the PUCCH resource and a number or identification of UEs that transmit the PUCCH may not be required. Alternatively, such as when a serving gNB needs to identify UEs that do not correctly receive DCI format 2_8 for example in order to determine a possible link adaptation for the PDCCH transmission providing the DCI format 2_8 , the PUCCH resource may be provided by UE-specific RRC signaling.

A timing/slot for the PUCCH transmission may be defined in the specifications of the system operation, or may be provided to the UE by higher layers such as a SIB or UE-specific RRC signaling. For example, as decoding of a DCI format may require only a few symbols of a slot, at least for SCS up to 120 kHz, a slot of the PUCCH transmission may be defined to be a next available slot after a slot of a PDCCH reception that provides DCI format 2_8. A UE may determine slots of PDCCH receptions that provide DCI format 2_8 based on corresponding search space sets that are indicated to the UE by a serving gNB. For example, with reference to slots of PUCCH transmissions, a slot of the PUCCH transmission may be indicated by higher layers through an offset relative to the slot of a PDCCH reception providing DCI format 2_8.

If a UE would transmit a first PUCCH providing UCI, or a PUSCH, in a slot that would overlap with a second PUCCH indicating an incorrect reception for a DCI format 2_8, in a first embodiment, the UE may multiplex information corresponding to the actual reception outcome for DCI format 2_8 by treating it as acknowledgment information having either ACK or NACK value, together with the other UCI using a PUCCH resource associated with the first PUCCH, or in the PUSCH, where the multiplexing may be as defined in TS 38.212 v17.2.0 and TS 38.213 v17.2.0. In a second embodiment, the UE may refrain from performing any multiplexing and transmit only the first PUCCH. The serving gNB may indicate, by higher layers, to the UE to apply the first or the second embodiment.

When there are more than one PDCCH monitoring occasions within a periodicity of PDCCH monitoring occasions for DCI format 2_8, or when there are more than one search space sets associated with DCI format 2_8, a slot of the PUCCH transmission by a UE may be with reference to the slot of the PDCCH reception, among the more than one PDCCH receptions, that ends last. Also, the UE may transmit the PUCCH when the UE incorrectly receives DCI format 2_8 in all associated PDCCH monitoring occasions, including possibly after combining two or more PDCCH receptions. For example, when there are two PDCCH receptions for DCI format 2_8 by the UE in a slot, the UE may transmit a PUCCH when the UE incorrectly receives the DCI format 2_8 for both PDCCH receptions and may also for the combination of the PDCCH receptions, for example when the UE indicates a capability to combine soft metrics from two PDCCH receptions prior to decoding for DCI format 2_8. For example, when there are two PDCCH receptions for DCI format 2_8 by the UE in two respective slots, the UE may determine a slot for the PUCCH transmission (when the UE incorrectly receives DCI format 2_8 for both PDCCH receptions and, possibly, for their combination) based on a slot offset from the later of the two slots for the PDCCH receptions.

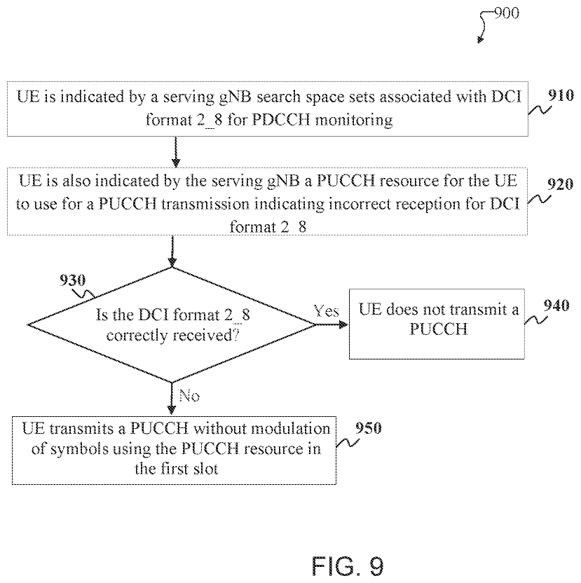

FIG. 9 illustrates an example method 900 for a UE to transmit a PUCCH indicating incorrect reception for a DCI format 2_8 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for a UE to transmit a PUCCH indicating incorrect reception for a DCI format 2_8 could be used without departing from the scope of this disclosure.

As illustrated in FIG. 9, the method 900 begins at step 910. At step 910, a UE is indicated by a serving gNB search space sets associated with DCI format 2_8 for PDCCH monitoring. At step 920, the UE is also indicated by the serving gNB a PUCCH resource for the UE to use for a PUCCH transmission indicating incorrect reception for DCI format 2_8. Each indication may be by a SIB or by UE-specific RRC signaling. With reference to slots of PUCCH transmissions, a slot offset for a first slot for the PUCCH transmission relative to a second slot of a PDCCH reception providing DCI format 2_8 may be defined in the specifications of the system operation or can be indicated by the serving gNB to the UE via higher layer signaling. At step 930, the UE determines whether the DCI format 2_8 is correctly received. When the DCI format 2_8 is correctly received, at step 940, the UE does not transmit a PUCCH; otherwise, at step 950, the UE transmits a PUCCH without modulation of symbols using the PUCCH resource in the first slot.

Although FIG. 9 illustrates one example of a method 900 for a UE to transmit a PUCCH indicating incorrect reception for a DCI format 2_8, various changes may be made to FIG. 9. For example, while shown as a series of steps, various steps in FIG. 9 could overlap, occur in parallel, occur in a different order, or occur any number of times.

When a serving gNB determines a PUCCH reception indicating incorrect reception by UEs of a DCI format 2_8 , the gNB may transmit again PDCCHs providing DCI format 2_8 so that all UEs may obtain an indication of a NW operation state. The UEs may start receptions of the PDCCHs in a slot having a slot offset from the slot of the PUCCH transmission that is defined in the specifications of the system operation, or reception of the PDCCHs may be indicated by the serving gNB via a SIB or via UE-specific RRC signaling. For example, as a determination by the serving gNB for an existence of a PUCCH reception may be done within a few symbols and as an encoding of DCI format 2_8 may also be done within a few symbols, if not already available at the serving gNB, a slot for the PDCCH transmissions may be 1 or 2 slots after a last slot for PDCCH transmissions that overlaps with the slot of the PUCCH reception. The slot offset may be with reference to slots of the active DL BWP for the UEs. Alternatively, the slot offset may be with reference to slots of a predefined SCS such as 15 kHz or 30 kHz, or to slots of the SCS of an initial DL BWP, or to slots of PUCCH transmissions.

Search space sets for PDCCH receptions in response to a PUCCH transmission indicating incorrect reception of a DCI format 2_8 may be the same as the search space sets for the initial receptions of PDCCHs providing DCI format 2_8 prior to the PUCCH transmission indicating incorrect reception of DCI format 2_8 , and the CRC bits of the DCI format 2_8 provided by the initial PDCCH receptions and the CRC bits of the DCI format 2_8 provided by the PDCCH receptions in response to the PUCCH transmission can be scrambled by a same or different RNTI. The start of the search space sets may be determined based on the slot offset as previously described.

If a UE does not correctly receive the DCI format 2_8 after new PDCCH receptions that are triggered by a PUCCH transmission from the UE indicating a previous incorrect reception of DCI format 2_8, the UE may or may not retransmit a PUCCH. A number of times that a UE may transmit a PUCCH indicating incorrect reception of DCI format 2_8 may be indicated to the UE by higher layers or be defined in the specifications of the system operation. For example, as a probability that the UE would incorrectly receive DCI format 2_8 after two or more receptions is typically small and as channel/interference diversity is provided by receptions at different times, a PUCCH transmission may be specified to occur once and, additionally, that may also apply for additional PDCCH receptions providing DCI format 2_8.

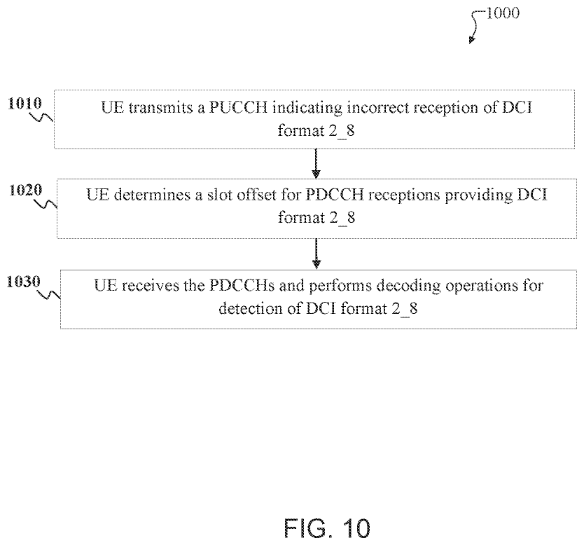

FIG. 10 illustrates an example method 1000 for a UE to receive PDCCH candidates for detection of DCI format 2_8 after the UE transmits a PUCCH indicating incorrect reception of DCI format 2_8 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for a UE to receive PDCCH candidates for detection of DCI format 2_8 after the UE transmits a PUCCH indicating incorrect reception of DCI format 2_8 could be used without departing from the scope of this disclosure.

As illustrated in FIG. 10, the method 1000 begins at step 1010. At step 1010, a UE transmits a PUCCH indicating incorrect reception of DCI format 2_8. At step 1020, the UE determines a slot offset for PDCCH receptions providing DCI format 2_8. At step 1030, the UE receives the PDCCHs and performs decoding operations for detection of DCI format 2_8. The PDCCH receptions may be according to same search space sets as for prior to the PUCCH transmission or may be according to separate search space sets indicated for PDCCH receptions providing DCI format 2_8 after a first PUCCH transmission indicating incorrect reception of DCI format 2_8.

Although FIG. 10 illustrates one example of a method 1000 for a UE to receive PDCCH candidates for detection of DCI format 2_8 after the UE transmits a PUCCH indicating incorrect reception of DCI format 2_8 , various changes may be made to FIG. 10. For example, while shown as a series of steps, various steps in FIG. 10 could overlap, occur in parallel, occur in a different order, or occur any number of times.

If a UE does not correctly receive DCI format 2_8 after a last PDCCH reception in a period of PDCCH receptions that provide DCI format 2_8, the UE may communicate with the serving gNB according to parameters that are previously indicated to the UE by higher layers, for example in a SIB. For example, the UE may receive PDCCH according to search space sets that are indicated for use when the UE does not have valid information for a NW operation state. For example, the UE may transmit a PUCCH providing SR according to a configuration that is applicable when the UE does not have valid information for a NW operation state. For example, if after the UE transmits a PUCCH providing a positive SR and receives a DCI format according to search space sets associated with the case that the UE does not have valid information for a NW operation state (the UE failed to correctly receive a DCI format 2_8 in first, or last, or any of PDCCH receptions for DCI format 2_8 ) scheduling a PUSCH transmission, the UE may indicate in the PUSCH transmission, for example via a MAC CE, that the UE does not know the latest NW operation state and then the serving gNB may indicate to the UE the latest NW operation state, for example via a MAC CE or UE-specific RRC signaling in a PDSCH reception. After the UE receives an indication for a NW operation state, the UE may communicate with the gNB according to parameters associated with the NW operation state.

If a NW operation state does not support transmissions or receptions by the serving gNB, the penalty of a UE transmitting or receiving when the UE does not know the NW operation state may be some unnecessary PDCCH receptions or PUCCH transmissions with SR from the UE. Such unnecessary transmissions and receptions may be controlled by the gNB through the indication of respective search space sets and the indication for a periodicity of PUCCH transmissions.

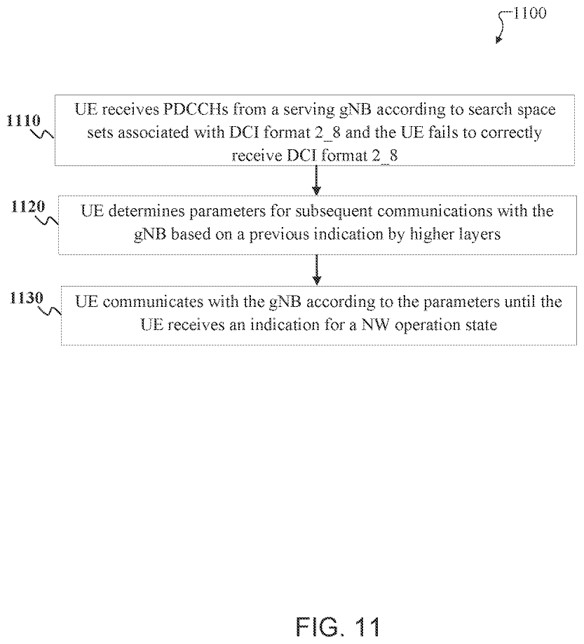

FIG. 11 illustrates an example method 1100 for a UE to communicate with a serving gNB after the UE fails to correctly receive a DCI format 2_8 indicating a NW operation state according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for a UE to communicate with a serving gNB after the UE fails to correctly receive a DCI format 2_8 indicating a NW operation state could be used without departing from the scope of this disclosure.

As illustrated in FIG. 11, the method 1100 begins at step 1110. At step 1110 a UE receives PDCCHs from a serving gNB according to search space sets associated with DCI format 2_8 and the UE fails to correctly receive DCI format 2_8 (as determined based on a respective CRC check). At step 1120, the UE determines parameters for subsequent communications with the gNB based on a previous indication by higher layers. At step 1130, the UE communicates with the gNB according to the parameters until the UE receives an indication for a NW operation state 1130.

Although FIG. 11 illustrates one example of a method 1100 for a UE to communicate with a serving gNB after the UE fails to correctly receive a DCI format 2_8 indicating a NW operation state, various changes may be made to FIG. 11. For example, while shown as a series of steps, various steps in FIG. 11 could overlap, occur in parallel, occur in a different order, or occur any number of times.

A UE may exclude PDCCH receptions providing DCI format 2_8 from an indication by a serving gNB for the UE to not receive PDCCHs over a time period. For example, as described in TS 38.213 v17.2.0 and TS 38.321 v17.1.0, a UE may receive a DCI format 2_5 indicating to the UE to skip PDCCH receptions for Type-3 CSS sets for a next C-DRX cycle, that is to not start the onDurationTimer, or receive a DCI format 2_7 or a DCI format with CRC scrambled by C-RNTI indicating to the UE to skip PDCCH receptions for Type-3 CSS sets or for USS sets for a time duration. Then, even when DCI format 2_8 is provided by PDCCH receptions according to a Type-3 CSS set, the UE may exclude those PDCCH receptions from an indication to skip PDCCH receptions and receive the corresponding PDCCHs for search space sets associated with DCI format 2_8. If additional DCI formats are associated with a search space set that is associated with DCI format 2_8, the UE may perform decoding operations also for those additional DCI formats.

UE-triggered PDCCH transmissions from a serving gNB may also be based on a PUCCH transmission by the UE that indicates a request for the gNB to change a NW operation state. For example, when a NW operation state is one where the gNB does not support transmissions or receptions, the gNB may indicate to the UE, in advance using higher layer signaling, to transmit a PUCCH at indicated transmission occasions (TOs) using a PUCCH resource from an indicated set of PUCCH resources to request the gNB to change the NW operation state, for example when the UE generates data to transmit to the gNB or when the UE needs to perform measurements based on receptions of SS/PBCH blocks or of CSI-RS from the gNB. The PUCCH resource may be associated with a NW operation state and different PUCCH resources can be indicated for use by a UE to indicate a respective NW operation state. Then, similar to a PUCCH transmission to indicate incorrect reception of DCI format 2_8, the UE may start monitoring PDCCHs for detection of DCI format 2_8 after the UE transmits a PUCCH that indicates a request to the gNB to change a NW operation state. The UE may determine a slot to start PDCCH monitoring after a number of slots from the slot of the PUCCH transmission. The number of slots may be determined as previously described for a PUCCH transmission indicating incorrect reception of DCI format 2_8.

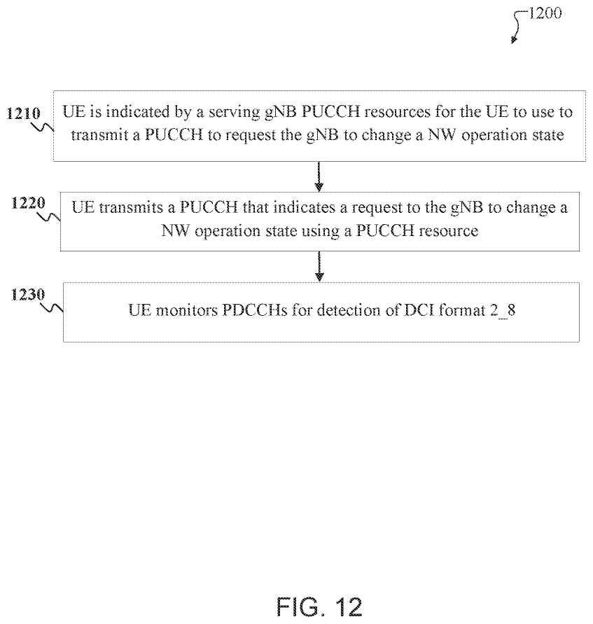

FIG. 12 illustrates an example method 1200 for a UE to communicate with a serving gNB after the UE fails to correctly receive a DCI format 2_8 indicating a NW operation state according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of UE communication with a serving gNB could be used without departing from the scope of this disclosure.

As illustrated in FIG. 12, the method 1200 begins at step 1210. At step 1210, a UE is indicated by a serving gNB PUCCH resources for the UE to use/select from to transmit a PUCCH and request the gNB to change a NW operation state 1210. At step 1220, the UE transmits a PUCCH that indicates a request to the gNB to change a NW operation state using a PUCCH resource from the PUCCH resources. At step 1230, the UE subsequently monitors PDCCHs for detection of DCI format 2_8.

Although FIG. 12 illustrates one example of a method 1200 for a UE to communicate with a serving gNB after the UE fails to correctly receive a DCI format 2_8 indicating a NW operation state, various changes may be made to FIG. 12. For example, while shown as a series of steps, various steps in FIG. 12 could overlap, occur in parallel, occur in a different order, or occur any number of times.

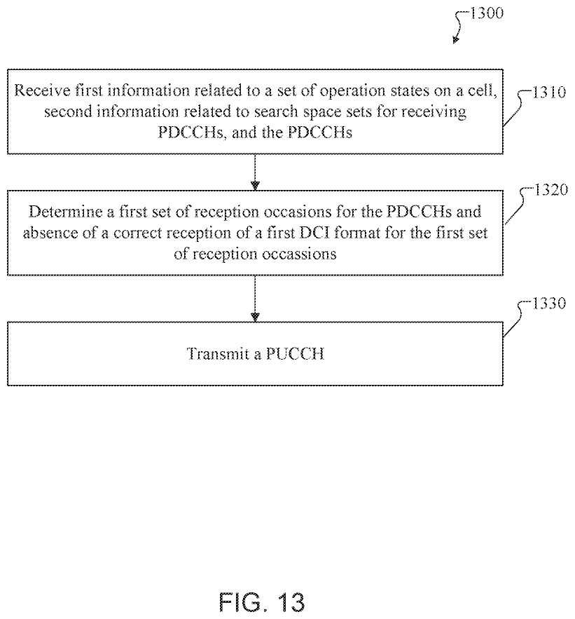

FIG. 13 illustrates an example method 1300 for reporting a decoding outcome of a DCI format.

As illustrated in FIG. 13, the method 1300 begins at step 1310. At step 1310, a UE receives first information to a set of operation states on a cell, second information related to search space sets for receiving PDCCHs, and the PDCCHs. In one embodiment, a first PDCCH from the PDCCHs provides a first DCI format, CRC bits of the first DCI format are scrambled by a first RNTI, and the first DCI format indicates first index from a set of indices corresponding to the set of operation states on the cell. At step 1320, the UE determines a first set of reception occasions for the first PDCCHs and absence of a correct reception of the first DCI format for the first set of reception occasions. At step 1330, the UE transmits a PUCCH. In one embodiment, the transmission is in response to the absence of the reception of the first DCI format for the set of reception occasions.

Although FIG. 13 illustrates one example of a method 1300 for reporting a decoding outcome of a DCI format, various changes may be made to FIG. 13. For example, while shown as a series of steps, various steps in FIG. 13 could overlap, occur in parallel, occur in a different order, or occur any number of times.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A user equipment (UE) comprising:
a transceiver configured to receive:
first information related to a set of operation states on a cell,
second information related to search space sets for receiving physical downlink control channels (PDCCHs), wherein:
a first PDCCH from the PDCCHs provides a first downlink control information (DCI) format,
cyclic redundancy check (CRC) bits of the first DCI format are scrambled by a first radio network temporary identifier (RNTI), and
the first DCI format indicates a first index from a set of indices corresponding to the set of operation states on the cell, and the PDCCHs; and
a processor operably coupled to a transceiver, the processor configured to determine:
a first set of reception occasions for the PDCCHs, and
absence of a correct reception of the first DCI format for the first set of reception occasions,
wherein the transceiver is further configured to transmit a physical uplink control channel (PUCCH) in response to the absence of the reception of the first DCI format in the first set of reception occasions.

2. The UE of claim 1, wherein:
the first index indicates a value of a parameter,
the value of the parameter is associated with one operation state from the set of operation states on the cell, and
the parameter indicates a configuration for transmissions in one of:
a power domain,
a frequency domain,
a time domain, and
a spatial domain.

3. The UE of claim 1, wherein the search space sets include:
a first common search space (CSS) set associated only with the first DCI format, and
a second CSS set associated with the first DCI format and with a second DCI format with CRC bits scrambled by a second RNTI.

4. The UE of claim 1, wherein the receptions of the PDCCHs are in an initial bandwidth part (BWP).

5. The UE of claim 1, wherein:
the processor is further configured to determine a second set of reception occasions for the PDCCHs in response to the absence of the correct reception of the first DCI format for the first set of reception occasions; and
the transceiver is further configured to receive the PDCCHs in the second set of reception occasions.

6. The UE of claim 1, wherein:
the transceiver is further configured to receive a system information block (SIB);
the processor is further configured to determine a resource for the PUCCH transmission based on information in the SIB; and
the transceiver is further configured to transmit the PUCCH using the resource.

7. The UE of claim 1, wherein:
the transceiver is further configured to receive information for an operation state in a system information block (SIB), and
the processor is further configured to determine receptions according to the operation state in response to the absence of the correct reception of the first DCI format in the first set of reception occasions.

8. A base station (BS) comprising:
a transceiver configured to transmit:
first information related to a set of operation states on a cell,
second information related to search space sets for transmitting physical downlink control channels (PDCCHs), wherein:
a first PDCCH from the PDCCHs provides a first downlink control information (DCI) format,
cyclic redundancy check (CRC) bits of the first DCI format are scrambled by a first radio network temporary identifier (RNTI), and
the first DCI format indicates a first index from a set of indices corresponding to the set of operation states on the cell, and
the PDCCHs; and
a processor operably coupled to a transceiver, the processor configured to determine a first set of transmission occasions for the PDCCHs,
wherein the transceiver is further configured to receive a physical uplink control channel (PUCCH) in response to the transmission of the first DCI format in the first set of transmission occasions.

9. The BS of claim 8, wherein:
the first index indicates a value of a parameter,
the value of the parameter is associated with one operation state from the set of operation states on the cell, and
the parameter indicates a configuration for receptions in one of:
a power domain,
a frequency domain,
a time domain, and
a spatial domain.

10. The BS of claim 8, wherein the search space sets include:
a first common search space (CSS) set associated only with the first DCI format, and
a second CSS set associated with the first DCI format and with a second DCI format with CRC bits scrambled by a second RNTI.

11. The BS of claim 8, wherein the transmissions of the PDCCHs are in an initial bandwidth part (BWP).

12. The BS of claim 8, wherein:
the transceiver is further configured to transmit a system information block (SIB);
the processor is further configured to determine a resource for the PUCCH reception based on information in the SIB; and
the transceiver is further configured to receive the PUCCH using the resource.

13. The BS of claim 8, wherein:
the transceiver is further configured to transmit information for an operation state in a system information block (SIB), and
the processor is further configured to determine transmissions according to the operation state in response to the transmission of the first DCI format in the first set of transmission occasions.

14. A method comprising:
receiving:
first information related to a set of operation states on a cell,
second information related to search space sets for receiving physical downlink control channels (PDCCHs), wherein:
a first PDCCH from the PDCCHs provides a first downlink control information (DCI) format,
cyclic redundancy check (CRC) bits of the first DCI format are scrambled by a first radio network temporary identifier (RNTI), and
the first DCI format indicates a first index from a set of indices corresponding to the set of operation states on the cell, and
the PDCCHs; and
determining:
a first set of reception occasions for the PDCCHs, and
absence of a correct reception of the first DCI format for the first set of reception occasions; and
transmitting a physical uplink control channel (PUCCH) in response to the absence of the reception of the first DCI format in the first set of reception occasions.

15. The method of claim 14, wherein:
the first index indicates a value of a parameter,
the value of the parameter is associated with one operation state from the set of operation states on the cell, and
the parameter indicates a configuration for transmissions in one of:
a power domain,
a frequency domain,
a time domain, and
a spatial domain.

16. The method of claim 14, wherein the search space sets include:
a first common search space (CSS) set associated only with the first DCI format, and
a second CSS set associated with the first DCI format and with a second DCI format with CRC bits scrambled by a second RNTI.

17. The method of claim 14, wherein the receptions of the PDCCHs are in an initial bandwidth part (BWP).

18. The method of claim 14, further comprising:
determining a second set of reception occasions for the PDCCHs in response to the absence of the correct reception of the first DCI format for the first set of reception occasions; and
receiving the PDCCHs in the second set of reception occasions.

19. The method of claim 14, further comprising:
receiving a system information block (SIB);
determining a resource for the PUCCH transmission based on information in the SIB; and
transmitting the PUCCH using the resource.

20. The method of claim 14, further comprising:
receiving information for an operation state in a system information block (SIB); and
determining receptions according to the operation state in response to the absence of the correct reception of the first DCI format in the first set of reception occasions.
